(19) United States
(12) Patent Application Publication
(10) Pub. No.: US 2016/0176353 A1
(43) Pub. Date: Jun. 23, 2016

(54) LOCKING LADDER RACK

(71) Applicant: Michael Snyder, French Settlement, LA (US)

(72) Inventor: Michael Snyder, French Settlement, LA (US)

(21) Appl. No.: 14/580,213

(22) Filed: Dec. 22, 2014

(51) Int. Cl. B60R 9/048

(52) U.S. Cl. CPC B60R 9/0485

(57) ABSTRACT

The present invention is a method and apparatus for attaching a ladder to a vehicle or trailer which is capable of securing and locking a ladder in place with a reduction in complexity and increased ease of use.

This application is a continuation of U.S. patent application Ser. No. 29/452,468, filed on Apr. 16, 2013, which is a continuation of U.S. patent application Ser. No. 29/432,997, filed on Sep. 24, 2012, which is a continuation of U.S. patent application Ser. No. 12/825,227 filed on Jun. 28, 2010, all of which are hereby incorporated by reference in their entirety.

### BACKGROUND OF THE INVENTION

The present invention relates to an apparatus for mounting, securing and locking a ladder to a vehicle or trailer.

Ladders are traditionally mounted on a vehicle or trailer in various ways, most of which involve a ladder rack, or hooks to which the ladder is attached. A ladder rack is typically mounted to the top or side of the vehicle or trailer, and the ladder is placed upon the rack (if top mounted) or hooked onto a rack or series of hooks (if side mounted). In this way, the ladder either rests on the rack above the vehicle or trailer, or is dangling from the side on attachments points mounted vertically on the vehicle or trailer.

While this may provide a user with a way to attach a ladder to a vehicle or trailer, the need may also arise wherein a user is also in need of securing a ladder to the vehicle or trailer to prevent unauthorized use, or simply to ensure the ladder does not detach from the vehicle or trailer unexpectedly. Having the ladder only resting or dangling leaves it susceptible to accidental dismounting while the vehicle is in motion, which can cause damage not only to the ladder, but severe damage to other vehicles and persons who may come in contact with a ladder that becomes dismounted from the vehicle or trailer. Thus, sometimes it is preferable to secure the ladder to the vehicle or trailer. In order to reach that end, some ladder users will attempt makeshift techniques to secure a ladder, such as bungee cords, chains with or without padlocks, or in the alternative, some locking mechanisms have been proffered in the industry which utilize cumbersome mechanisms and/or apparatus to lock and/or secure a ladder.

Clear downsides to the current mode of attaching a ladder to a vehicle or trailer exist. Firstly, a simple easy solution for mounting has not yet been available in the field. Secondly, even while the common method of attaching a ladder to a vehicle or trailer may perform the task of keeping the ladder mounted well enough to function, no known solution secures the ladder and prevents the unauthorized removal of the ladder in any reasonable fashion. This leaves the ladder vulnerable to theft, or use by an unauthorized party who may cause injury to themselves or others. For those methods employed by others to secure the ladder, the process is overwrought and typically not a unified locking system, and is therefore inherently subject to failure and damage because the solution is not designed as part of the ladder mount.

The consequence of these issues is the inherent ineffectiveness of the current state of the art for mounting ladders. The absence of a solution which provides a secure, lockable and easy way to mount a ladder to a vehicle or trailer has yet to be developed. The present invention provides a simple, secure and lockable apparatus for ladders to be detachably affixed to a vehicle or trailer. The present invention of a locking ladder rack is thus a novel, needed and functional answer to the problems in the field relating to securing ladders.

All of these aspects of the current state of ladder mounts for vehicles or trailers lead to an increased need for a revised method of implementation with minimized cost and complexity, all of which the present invention addresses.

### OBJECTS OF THE INVENTION

One object of the invention is to provide a lockable ladder mounting system.

An additional object of this invention is to provide a simple apparatus for securing a ladder to a vehicle or trailer.

Another object of this invention is to provide a secure ladder mounting system.

Yet another object of this invention is to provide a ladder mounting system that is lockable.

Still another object of this invention is to provide a ladder mounting system that is easy to use.

Other objects and advantages of this invention shall become apparent from the ensuing descriptions of the invention.

### SUMMARY OF THE INVENTION

According to the present invention, a method and apparatus for attaching a ladder to a vehicle or trailer is disclosed which is capable of securing and locking a ladder in place with a reduction in complexity and increased ease of use.

### BRIEF DESCRIPTION OF THE DRAWINGS

The accompanying drawings and figures illustrate an embodiment of this invention. However, it is to be understood that this embodiment is intended to be neither exhaustive, nor limiting of the invention. They are but examples of some of the forms in which the invention may be practiced.

FIG. 1 is a perspective view of the locking ladder rack.

FIG. 2 is a left side view of the locking ladder rack.

FIG. 3 is a right side view of the locking ladder rack.

FIG. 4 is a rear view of the locking ladder rack.

FIG. 5 is a top view of the locking ladder rack.

FIG. 6 is a bottom view of the locking ladder rack.

FIG. 7 is a front view of the locking ladder rack.

FIG. 8 is a view of the locking ladder rack installed on a truck.

### DETAILED DESCRIPTION OF EXEMPLARY EMBODIMENTS

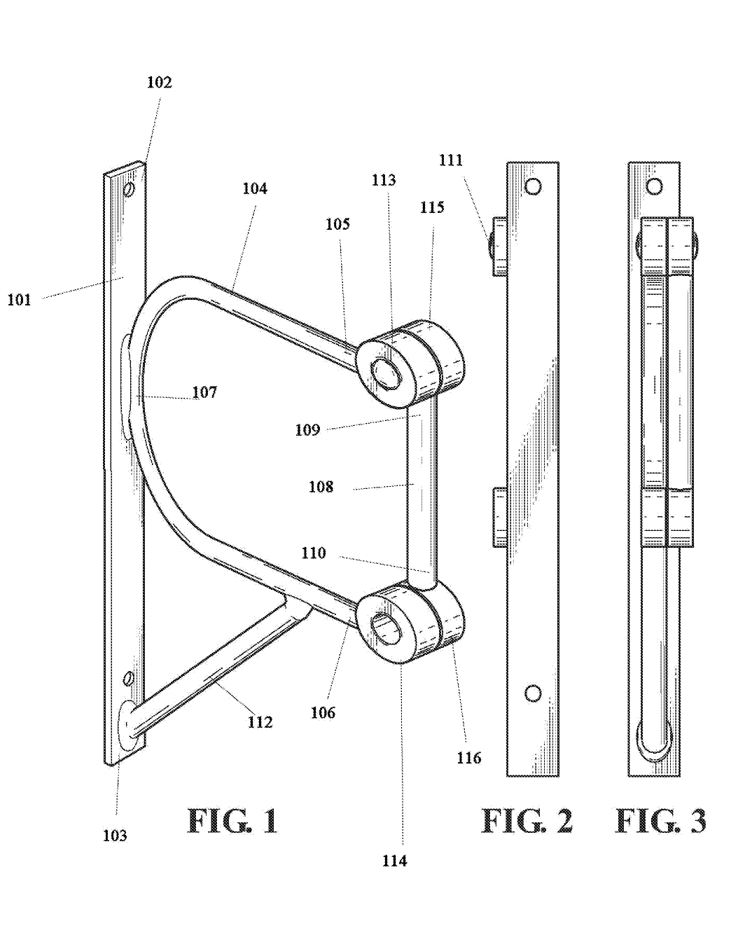

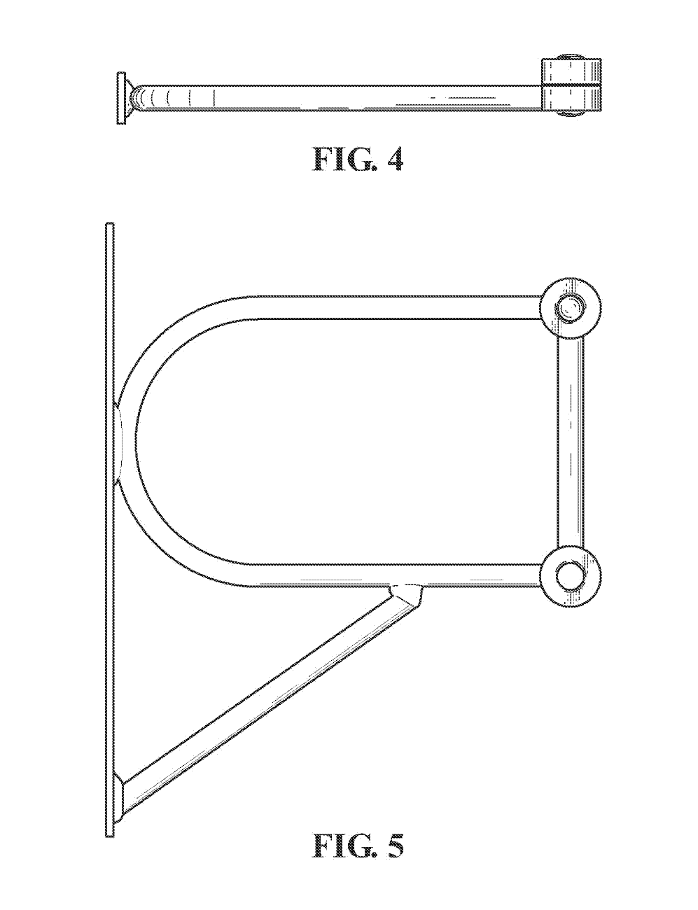

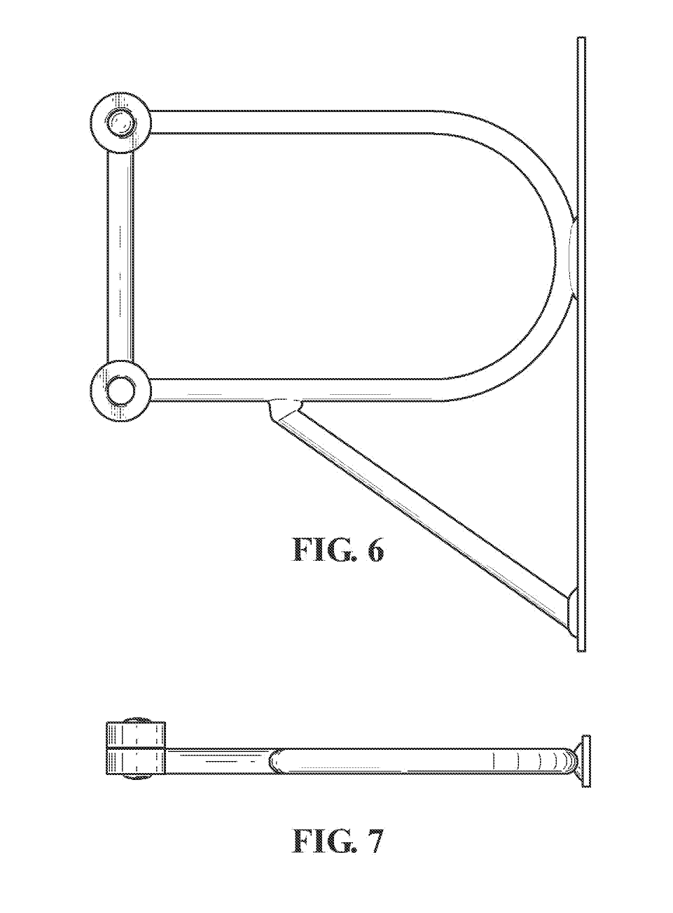

Without any intent to limit the scope of this invention, reference is made to the figures in describing the various embodiments of the invention. FIGS. 1 through 8 depict various aspects of exemplary embodiments of the present invention.

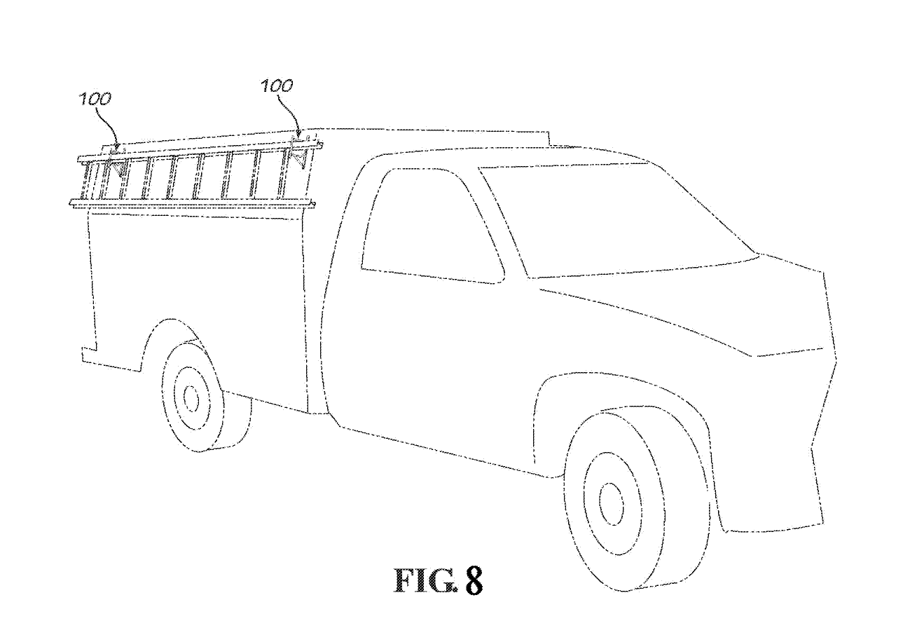

The present invention relates to lockable ladder rack 100 as pictured in FIGS. 1 through 7 and mounted to a vehicle as see in FIG. 8. Any type of vehicle 200 can conceivably be used, but most often, vehicle 200 would be a truck, van or trailer. Lockable ladder rack 100 is, in one exemplary embodiment, constructed primarily of mounting plate 101, u-shaped member 104 and securing member 108. Mounting plate 101 can be configured to mount to vehicle or trailer 200 as seen in FIG. 3.

Mounting plate 101 has first opposite end 102 and second opposite end 103, and is, in this exemplary embodiment, constructed of a durable and strong material, such as steel, but could be aluminum, or high-impact plastic, provided the material was capable of supporting the weight of ladder 201. The shape of mounting plate 101 can also be of various types, such as circular, square or rectangular. In the pictured embodiment, a rectangular design is employed. Between first opposite end 102 and second opposite end 103 of mounting plate 101, is affixed mounted u-shaped member 104.

U-shaped member 104 can be constructed of a similar material as mounting plate 101. The general u-shape of u-shaped member 104 can be a sweeping u-type as pictured in the Figures, or could be a more squared off shape, provided the shape permits ladder 201 to be hung thereon. U-shaped member 104 can be affixed anywhere between first opposite end 102 and second opposite end 103 of mounting plate 101, however, in the exemplary embodiment pictured in the Figures, u-shaped member 104 is mounted at the approximate midpoint between first opposite end 102 and second opposite end 104. U-shaped member 104 also has two ends, namely, first receiving end 105 and second receiving end 106. Both ends 105, 106 can be configured as pictured with a circular or other void-providing shape such as a loop, where first receiving end 105 forms a first loop 113 and second receiving end 106 forms a second loop 114, which will permit a locking mechanism such as a pin, lock or the like to pass though. U-shaped member 104 additionally has radial midpoint 107, which would be typically where u-shaped member 104 would be affixed to mounting plate 101.

Securing member 108 can be of various shapes, but in the pictured embodiment of the Figures, it is a cylindrical member having first engaging end 109 and second engaging end 110, and wherein first engaging end 109 is shaped to be similar to receiving end 105 of u-shaped member 104 by forming a third loop 115. Second engaging end 110 is similarly configured to be similar to second receiving end 106 of u-shaped member 104 by forming a fourth loop 116. In this way, a locking mechanism 111, such as a pin, cable, lock or the like can be inserted through both pairs of loops to enable locking the apparatus 100.

A structural support member 112 can also be employed to support the load of whatever is placed in u-shaped member 104, or can be used to fortify the strength of u-shaped member 104 and mounting plate 101 if necessary, desired or preferred.

In operation, then, mounting plate 101 of lockable ladder rack 100 is affixed to a vehicle or trailer 200, as seen in FIG. 3 either by bolts, screws, welding, adhesive or any other choice of affixation for two or more locking ladder racks 100. In the exemplary embodiment, u-shaped member 104 is permanently affixed to mounting plate 101, but an alternate arrangement such as a detachable connection with screws or bolts is perfectly feasible and within the scope of this invention. Ladder 201 is then placed within the confines of locking ladder racks 100 along the length of ladder 201. For each locking ladder rack 100, securing member 108 is put in place by first attaching first receiving end 105 to first engaging end 109. Next, second receiving end 110 is attached to second engaging end 106. Both attachments are performed by the use of locking device 111, such as pin, cable or the like by passing through both first loop 113 and third loop 115 and second loop 114 and fourth loop 116. This effectively secures ladder 201 within locking ladder rack 100, and thus to vehicle or trailer 200.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A locking ladder rack comprising:
a. a mounting plate configured to be mounted to a vehicle having first and second opposite ends;
b. a u-shaped member having a first receiving end forming a first loop, a second receiving end forming a second loop, and a radial midpoint, and wherein said u-shaped member is affixably attached between said first and said second opposite ends of said mounting plate at approximately said radial midpoint of said u-shaped member;
c. a securing member having a first engaging end forming a third loop and a second engaging end forming a fourth loop, and wherein said first engaging end and said second engaging end are configured to couple with said first receiving end and said second receiving end of said u-shaped member by coupling said first loop to said third loop with a first locking mechanism and said second loop to said fourth loop with a second locking mechanism, and;
d. wherein said first and second locking mechanisms are shaped to pass through at least any one of said first loop, second loop, third loop or fourth loop.

2. The method of locking a ladder to a vehicle using the apparatus from claim 1 comprising the steps of:
a. attaching said mounting plate to said vehicle;
b. placing said ladder in said u-shaped member; and
c. affixing said securing member to said u-shaped member.
